(19) United States
(12) Patent Application Publication
(10) Pub. No.: US 2019/0329796 A1
(43) Pub. Date: Oct. 31, 2019

(54) HAPTIC FEEDBACK SYSTEM FOR A VEHICLE

(71) Applicant: Honda Motor Co., Ltd., Tokyo (JP)

(72) Inventor: Rahul KHANNA, Mountain View, CA (US)

(21) Appl. No.: 15/964,474

(22) Filed: Apr. 27, 2018

(51) Int. Cl. B60W 50/16; G06F 3/01; B62K 23/04; B62K 11/14; B62K 21/26; G08B 6/00

(52) U.S. Cl. CPC B60W 50/16; G06F 3/016; B62K 23/04; B60W 2300/36; B62K 21/26; G08B 6/00; G06F 3/014; B62K 11/14

(57) ABSTRACT

A haptic feedback system for a vehicle having a first handlebar and a second handlebar that provides data from the vehicle to an operator of the vehicle includes a data module for collecting data to be communicated to the operator of the vehicle, a wireless communication module for transmitting the data to be communicated to the operator of the vehicle, and at least one glove worn by the operator. The glove includes a wireless communication receiver for receiving the data transmitted by the wireless communication module, and a haptic communication apparatus in a wrist portion of the glove. The haptic communication apparatus conveys the data received by the wireless communication receiver to the operator, and a battery in the glove provides power to the wireless communication receiver and the haptic communication apparatus.

### TECHNICAL FIELD

The embodiments herein are related to the field of haptic feedback systems for vehicles in general, and more specifically vehicles that feature handlebars.

### BACKGROUND

Wearable or body-borne computers are known, such as smart telephones, personal digital assistants, smart watches, and the like. Additionally, it is known to include computers with wireless communication and vibration generators, and the like within wearable garments. However, in use with a handle barred vehicle, such as a motorcycle or all-terrain vehicle, there are limitations related to the vehicle. For example, motorcycles may naturally provide vibrations due to the nature of the vehicle travelling along a road that are not distinguishable from a typical vibration generator. Further, many wearable computers are not well suited for an open-air environment associated with these type of vehicles. Finally, alerts to the operators of these vehicles should be as unobtrusive as possible due to the open-air seating of the vehicle.

Therefore, there exists a need for a haptic feedback system that provides alerts to the operator of the handle barred vehicle that does not disturb or interfere with the attention of the operator, is operable in an open-air environment, and is distinguishable from natural vibrations associated with the operating conditions of the vehicle.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a haptic feedback system for a vehicle having a first handlebar and a second handlebar, the haptic feedback system providing data from the vehicle to an operator of the vehicle, includes a data module for collecting data to be communicated to the operator of the vehicle, a wireless communication module for transmitting the data to be communicated to the operator of the vehicle, and at least one glove worn by the operator. The at least one glove includes a wireless communication receiver for receiving the data transmitted by the wireless communication module, a haptic communication apparatus in a wrist portion of the at least one glove, the haptic communication apparatus conveying the data received by the wireless communication receiver to the operator, and a battery in the at least one glove for providing power to the wireless communication receiver and the haptic communication apparatus.

According to another aspect, a haptic feedback system for a vehicle having a first handlebar and a second handlebar, the haptic feedback system providing data from the vehicle to an operator of the vehicle, includes a data module for collecting data to be communicated to the operator of the vehicle, a wireless communication module for transmitting the data to be communicated to the operator of the vehicle, and first and second gloves worn by the operator. Each of the first and second gloves includes a wireless communication receiver for receiving the data transmitted by the wireless communication module, a haptic communication apparatus in a wrist portion each of the first and second gloves, the haptic communication apparatus conveying the data received by the wireless communication receiver to the operator, and a battery in each of the first and second gloves for providing power to the wireless communication receiver and the haptic communication apparatus.

According to yet another aspect, a haptic feedback system for a vehicle having a first handlebar and a second handlebar, the haptic feedback system providing data from the vehicle to an operator of the vehicle, includes a data module for collecting data to be communicated to the operator of the vehicle, a wireless communication module for transmitting the data to be communicated to the operator of the vehicle, and first and second gloves worn by the operator. Each of the first and second gloves include a wireless communication receiver for receiving the data transmitted by the wireless communication module, a haptic communication apparatus in a wrist portion each of the first and second gloves, the haptic communication apparatus conveying the data received by the wireless communication receiver to the operator, and a battery in each of the first and second gloves for providing power to the wireless communication receiver and the haptic communication apparatus. The haptic feed system further includes a first battery charging apparatus located in the first handlebar of the vehicle, the first battery charging apparatus charging the battery located in the first glove, a second battery charging apparatus located in the second handlebar of the vehicle, the second battery charging apparatus charging the battery located in the second glove, and wherein the data is related to one of an operating condition of the vehicle, an alert from a safety system of the vehicle, and an alert from an external source communicated to the vehicle.

### BRIEF DESCRIPTION OF THE DRAWINGS

FIG. 1 is a perspective view of a motorcycle.

FIG. 2 is a perspective view of an all-terrain vehicle.

FIG. 3 is a perspective view of a motorcycle with an operator.

FIG. 4 is a schematic view of a haptic feedback system.

FIG. 5 is a side view of one embodiment of a pair of gloves that form a component of the haptic feedback system of FIG. 4.

FIG. 6 is a perspective view of an embodiment of the handlebars of a vehicle that form a portion of the haptic feedback system of FIG. 4 and FIG. 5.

FIG. 7 is a side view of another embodiment of a pair of gloves that form a component of the haptic feedback system of FIG. 4.

FIG. 8 is a perspective view of an embodiment of the handlebars of a vehicle that form a portion of the haptic feedback system of FIG. 4 and FIG. 7.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

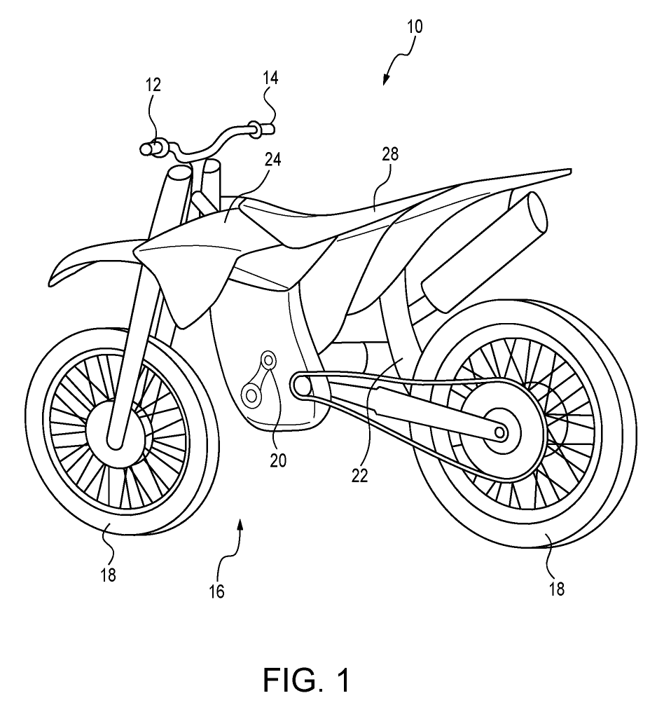

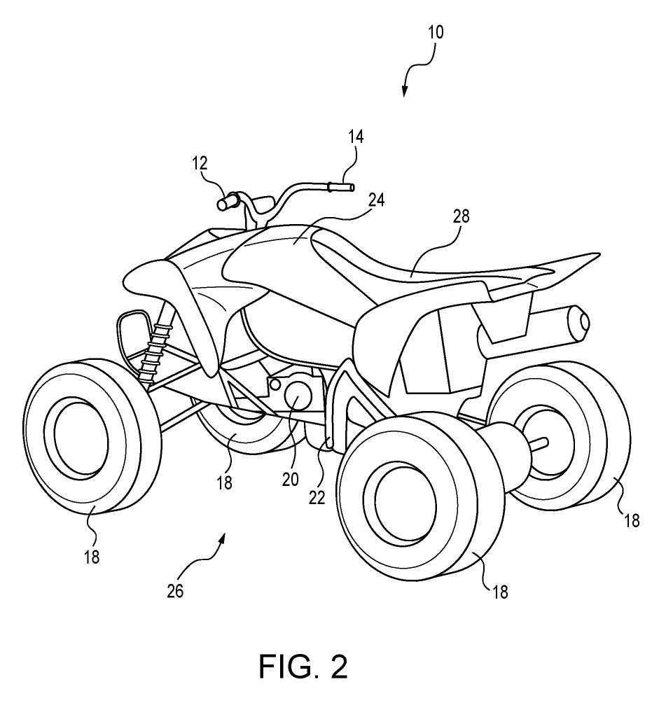

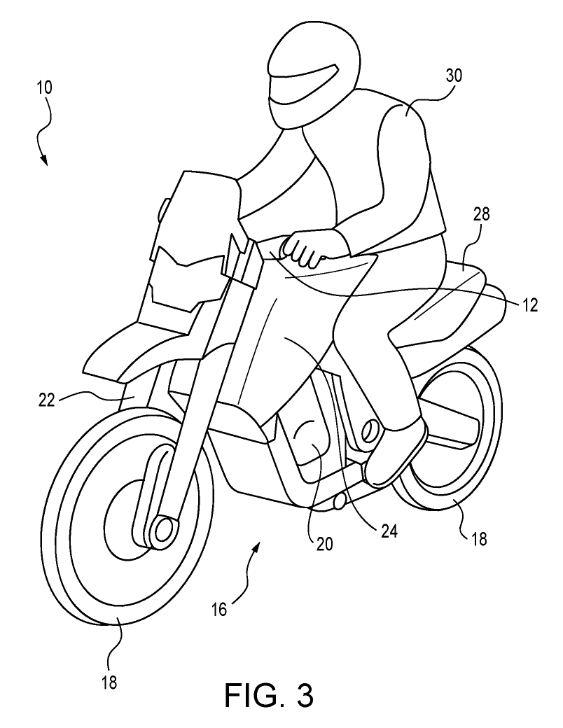

FIG. 1 illustrates a typical vehicle 10 with first and second handlebars 12, 14, typically a motorcycle 16, which may include two wheels 18, an engine 20, a frame 22, and a fuel tank 24. Although the embodiments described herein are related to a motorcycle 16, the vehicle 10 could also be of the type described as an all-terrain vehicle 26, as illustrated in FIG. 2. An all-terrain vehicle 26 is similar in operation to a motorcycle 16 as shown in FIG. 1, but may include three or four wheels 18 instead of two. Embodiments from herein out will be described in view of a motorcycle 16 illustrated in FIG. 1, but may apply equally to an all-terrain vehicle illustrated in FIG. 2. In both embodiments, as illustrated in FIG. 3, an operator 30 sits upon a seat 28 and uses the first and second handlebars 12, 14 to steer the vehicle 10.

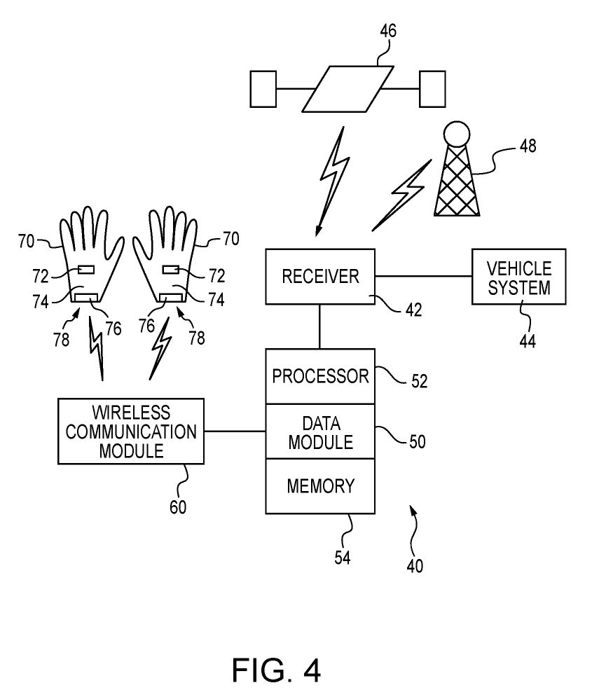

As illustrated schematically in FIG. 4, the vehicle 10 may include a haptic feedback system 40 for providing data from the vehicle 10 to the operator 30 of the vehicle 10. The data may be received by a receiver 42 from an onboard vehicle system 44, such as operating conditions of the vehicle 10, including fuel level warnings from the fuel tank 24, tire pressure monitoring data from the wheels 18, warnings on the operability of vehicle 10, at the like. The data may further include alerts from a safety system of the vehicle 10, such as a stability system, lane monitoring system, collision-warning system, and the like. Additionally, the data may be related to an alert from an external source communicated to the vehicle 10, such as weather alerts delivered to the vehicle 10 by satellite 46 or by a terrestrial wireless communication system 48.

The haptic feedback system 40 includes a data module 50 for collecting the data to be communicated to the operator 30 of the vehicle 10. The data module 50 may be in communication with the receiver 42 for receiving data from a data source. The data module 50 may include a processor 52 for processing the data and a memory 54 for storing the data of the type known to those skilled in the art. The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The haptic feedback system 40 includes a wireless communication module 60 for transmitting the data to be communicated to the operator 30 of the vehicle 10. The wireless communication module 60 may communicate the data using one or more radio technologies (e.g., 3GPP radio access technologies, IEEE 802.11, Bluetooth®, etc.).

The haptic feedback system 40 further includes at least one, and in an embodiment discussed herein, a pair of gloves 70 worn by the operator 30 of the vehicle 10. Each glove 70 may include a wireless communication receiver 72 for receiving the data transmitted by the wireless communication module 60. The wireless communication receiver 72 is configured to receive communications using one or more radio technologies (e.g., 3GPP radio access technologies, IEEE 802.11, Bluetooth®, etc.). The wireless communication receiver 72 may be located in any suitable location in each of the gloves 70. In the embodiment disclosed herein, the wireless communication receiver 72 is located in the back portion 74 of the glove 70 that covers the back portion of the hand of the operator 10. In the embodiments disclosed, the gloves 70 are constructed of a water resistant material to prevent water damage to any of the components discussed herein. The water resistant material may include, but is not limited to, leather, rubber, lycra, thermoplastics, urethane, polyurethane, polyester, polytex, or any other suitably water resistant material known to a person of ordinary skill in the art.

Each glove 70 may also include a haptic communication apparatus 76 in a wrist portion 78 of each glove 70. The haptic communication apparatus 76 conveys the data received by the wireless communication receiver 60 to the operator 60 through a series of tactile actuators 80 that may use forces, vibrations, or motions to convey information to the operator 30.

In the embodiments disclosed herein, the tactile actuators 80 may include eccentric rotating mass (ERM) actuators, linear resonant actuators (LRA), piezoelectric actuators, or any other haptic feedback actuator known to persons of ordinary skill in the art.

The haptic communication apparatus is located on the back portion 74 of the glove 70 at the wrist portion 78 of each glove 70. The back of the wrist is sensitive to the haptic signals, and the back of the wrist is also removed from, or is not proximate to, vibrations produced by the vehicle 10 that may otherwise be sensed by the operator 30 when holding the handlebars 12, 14 during the operation of the vehicle 10. Further, by employing haptic feedback to the operator 30 that relies on the sense of touch, the operator 30 is not required to divert attention from the riding or steering the vehicle 10.

Each glove 70 may also include a battery 82 for providing power to the wireless communication receiver 72 and the haptic communication apparatus 76. The battery 82 may be either a 1.5-volt or 3.0-volt watch or coin battery, or any other type of replaceable battery, or a rechargeable battery of variable voltages. The location of the battery 82 may vary based upon the type and size of the selected battery 82. A battery 82 should be located in a position in the glove 70 that does not require bending, gripping, or shear movements of the glove 70, such as the back portion 74 of the glove 70 that covers the back of the hand of the operator 30.

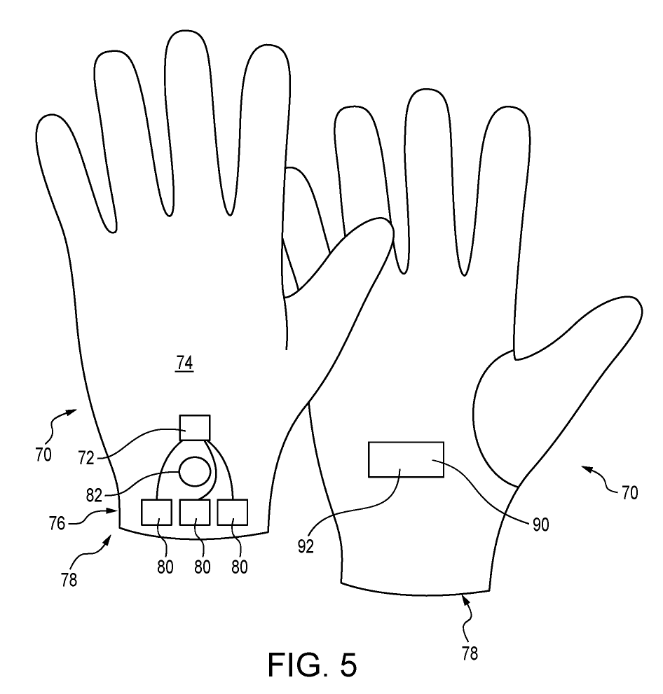

In an embodiment that employs a rechargeable battery as the battery 82, the rechargeable battery should also be located in a position in the glove 70 that does not require bending, gripping, or shear movements of the glove 70, and the rechargeable battery should also be located to be accessible to a recharging apparatus. The embodiment illustrated in FIG. 5 illustrates a rechargeable battery system for the glove.

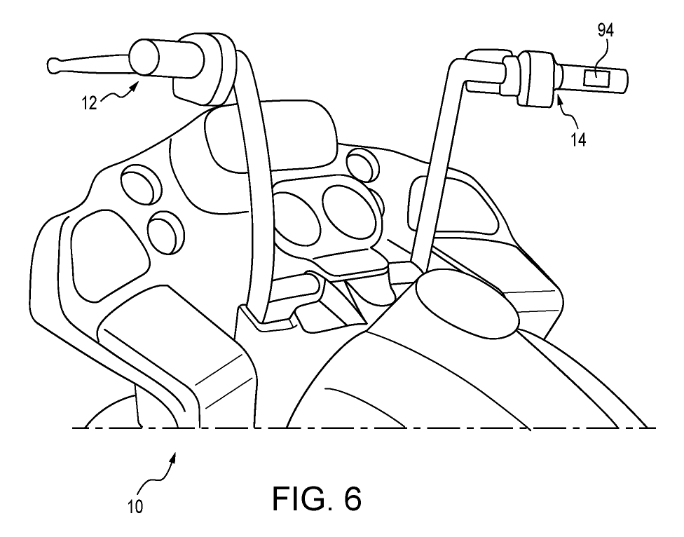

In one embodiment, illustrated in FIGS. 5-6 the battery charging apparatus 90 is located in the glove 70 so that, when the operator 30 is wearing the glove 70 and operating the vehicle 10, an induction coil 92 in electrical communication with the battery 82 is aligned with and proximate to a wireless induction charger 94 located in the associated handlebar 14 of the vehicle 10. Induction chargers use an induction coil to create an alternating electromagnetic field from within a charging base, and the induction coil 92 in the glove 70 takes power from the electromagnetic field and converts it back into electric current to charge the battery 82. A wireless induction charger 94 has the advantage of not be susceptible to weather or operating conditions of the vehicle 10.

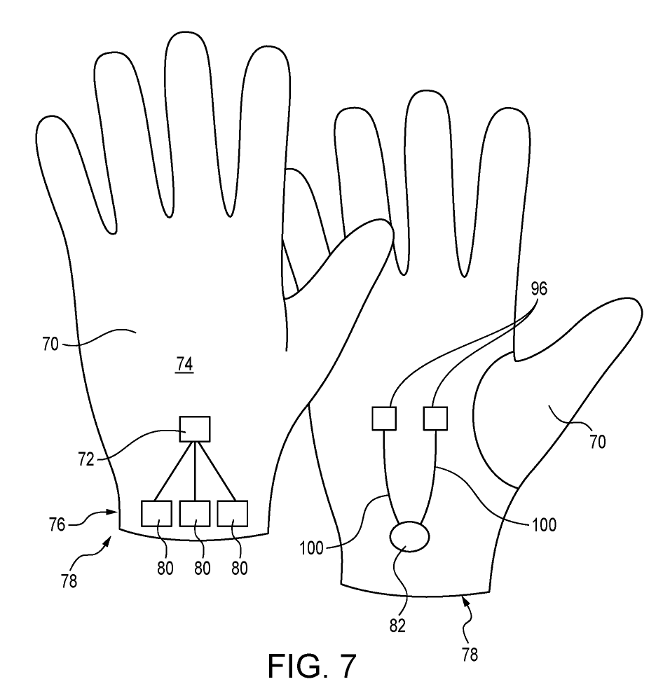

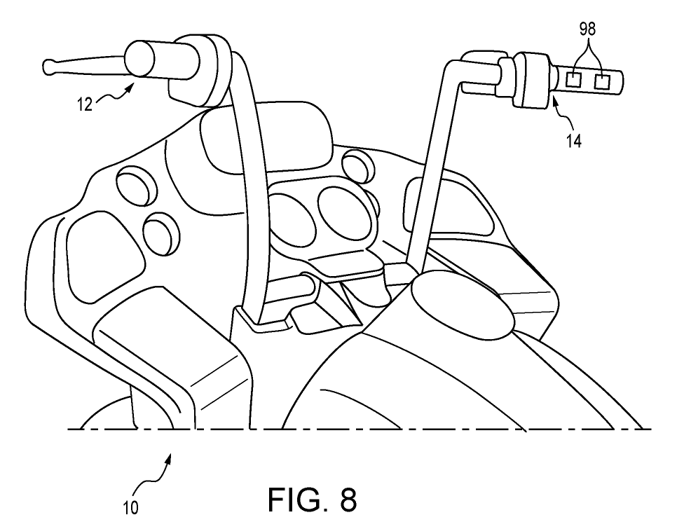

In an alternate embodiment shown in FIGS. 7-8, the glove 70 may include leads 96 that align with leads 98 on the handlebar 14 of the vehicle 10 when in operation by the operator 30. The leads 96 may, in turn, be attached to wires 100 that run through the glove to charge the rechargeable battery 82. In the handlebar 14, the leads 98 may be attached to an electric power source, such as the battery (not shown) of the vehicle 10 to provide electrical power to the leads for transference to the rechargeable battery 82.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

1. A haptic feedback system for a vehicle having a first handlebar and a second handlebar, the haptic feedback system providing data from the vehicle to an operator of the vehicle, comprising:
a data module for collecting data to be communicated to the operator of the vehicle;
a wireless communication module for transmitting the data to be communicated to the operator of the vehicle;
at least one glove worn by the operator, the at least one glove comprising:
a wireless communication receiver for receiving the data transmitted by the wireless communication module;
a haptic communication apparatus in a back portion of a wrist portion of the at least one glove, the haptic communication apparatus conveying the data received by the wireless communication receiver to the operator; and
a battery in the at least one glove for providing power to the wireless communication receiver and the haptic communication apparatus.

2. The haptic feedback system of claim 1 further comprising:
a battery charging apparatus located in the first handlebar of the vehicle, the battery charging apparatus charging the battery located in the at least one glove.

3. The haptic feedback system of claim 2 wherein the battery charging apparatus comprises a wireless inductive charger.

4. The haptic feedback system of claim 3 wherein the battery in the at least one glove is positioned to be proximate the wireless inductive charger when the least one glove is worn by the user of the vehicle and grips the first handlebar.

5. The haptic feedback system of claim 2 further comprising:
a connection from the battery charging apparatus exposed to an exterior surface of the first handlebar to charge the battery in the at least one glove.

6. The haptic feedback system of claim 1 wherein the data is related to an operating condition of the vehicle.

7. The haptic feedback system of claim 1 wherein the data is related to an alert from a safety system of the vehicle.

8. The haptic feedback system of claim 1 wherein the data is related to an alert from an external source communicated to the vehicle.

9. The haptic feedback system of claim 8 wherein the external source is a satellite.

10. A haptic feedback system for a vehicle having a first handlebar and a second handlebar, the haptic feedback system providing data from the vehicle to an operator of the vehicle, comprising:
a data module for collecting data to be communicated to the operator of the vehicle;
a wireless communication module for transmitting the data to be communicated to the operator of the vehicle;
first and second gloves worn by the operator, each of the first and second gloves comprising:
a wireless communication receiver for receiving the data transmitted by the wireless communication module;
a haptic communication apparatus in a back portion of a wrist portion of each of the first and second gloves, the haptic communication apparatus conveying the data received by the wireless communication receiver to the operator; and
a battery in each of the first and second gloves for providing power to the wireless communication receiver and the haptic communication apparatus.

11. The haptic feedback system of claim 10 further comprising:
a first battery charging apparatus located in the first handlebar of the vehicle, the first battery charging apparatus charging the battery located in the first glove; and
a second battery charging apparatus located in the second handlebar of the vehicle, the second battery charging apparatus charging the battery located in the second glove.

12. The haptic feedback system of claim 11 wherein the first battery charging apparatuses comprises a first wireless inductive charger and the second battery charging apparatus comprises a second wireless inductive charger.

13. The haptic feedback system of claim 12 wherein:
the battery in the first glove is positioned to be proximate the first wireless inductive charger when the first glove is worn by the operator of the vehicle and grips the first handlebar; and
the battery in the second glove is positioned to be proximate the second wireless inductive charger when the second glove is worn by the operator of the vehicle and grips the second handlebar.

14. The haptic feedback system of claim 11 further comprising:
a first connection from the first battery charging apparatus exposed to an exterior surface of the first handlebar to charge the battery in the first glove; and
a second connection from the second battery charging apparatus exposed to an exterior surface of the second handlebar to charge the battery in the second glove.

15. The haptic feedback system of claim 10 wherein the data is related to an operating condition of the vehicle.

16. The haptic feedback system of claim 10 wherein the data is related to an alert from a safety system of the vehicle.

17. The haptic feedback system of claim 10 wherein the data is related to an alert from an external source communicated to the vehicle.

18. The haptic feedback system of claim 17 wherein the external source is a satellite.

19. A haptic feedback system for a vehicle having a first handlebar and a second handlebar, the haptic feedback system providing data from the vehicle to an operator of the vehicle, comprising:
a data module for collecting data to be communicated to the operator of the vehicle;
a wireless communication module for transmitting the data to be communicated to the operator of the vehicle;
first and second gloves worn by the operator, each of the first and second gloves comprising:
a wireless communication receiver for receiving the data transmitted by the wireless communication module;
a haptic communication apparatus in a back portion of a wrist portion of each of the first and second gloves, the haptic communication apparatus conveying the data received by the wireless communication receiver to the operator; and
a battery in each of the first and second gloves for providing power to the wireless communication receiver and the haptic communication apparatus;
a first battery charging apparatus located in the first handlebar of the vehicle, the first battery charging apparatus charging the battery located in the first glove;
a second battery charging apparatus located in the second handlebar of the vehicle, the second battery charging apparatus charging the battery located in the second glove; and
wherein the data is related to one of an operating condition of the vehicle, an alert from a safety system of the vehicle, and an alert from an external source communicated to the vehicle.

20. The haptic feedback system of claim 19 wherein the external source is a satellite.
